(19) United States
(12) Patent Application Publication
(10) Pub. No.: US 2020/0300194 A1
(43) Pub. Date: Sep. 24, 2020

(54) Internal Combustion Engine Control Device and Internal Combustion Engine Control Method

(71) Applicant: Hitachi Automotive Systems, Ltd., Hitachinaka-shi, Ibaraki (JP)

(72) Inventors: Yoshiaki NAGASAWA, Ibaraki (JP); Masayuki SARUWATARI, Ibaraki (JP); Koji ONISHI, Ibaraki (JP)

(21) Appl. No.: 16/645,580

(22) PCT Filed: Jul. 18, 2018
(86) PCT No.: PCT/JP2018/026816

§ 371 Date: Mar. 9, 2020

(30) Foreign Application Priority Data
Sep. 21, 2017 (JP) 2017-180909

(51) Int. Cl. F02D 41/24; F02D 41/14

(52) U.S. Cl. CPC F02D 41/2454; F02D 35/023; F02D 41/1475; F02D 41/1441

(57) ABSTRACT

Misfire and torque fluctuation due to rapid combustion deterioration of an internal combustion engine can be reduced. An ECU of an engine which burns fuel in a cylinder includes a determination unit which determines a target air-fuel ratio of the engine on the basis of a variation in crank angle in a relatively small number of combustion cycles, or a difference in indicated average effective pressure from a previous combustion cycle, and an air-fuel ratio control unit which controls the air-fuel ratio of the engine to be the target air-fuel ratio determined by the determination unit. The determination unit shifts the target air-fuel ratio to a rich side when the variation exceeds a first setting value or when the difference exceeds a second setting value.

### TECHNICAL FIELD

The present invention relates to a control device for an internal combustion engine that burns fuel in a cylinder.

### BACKGROUND ART

Recently, various control methods for improving the control accuracy of a fuel injection amount, a fuel injection timing, and an ignition timing have been proposed for the purpose of reducing a fuel consumption amount and a harmful exhaust gas component. Further, for example, a new combustion method that uses both spark ignition and compression ignition has been proposed. In such a control method and combustion method, it is necessary to accurately grasp a combustion state in the cylinder (in-cylinder). Therefore, it is desirable to detect the in-cylinder combustion pressure (in-cylinder pressure) generated by the combustion in order to accurately grasp the combustion state in the cylinder.

Therefore, there is generally known a method for detecting an in-cylinder pressure by forming a hole communicating with a combustion chamber in a cylinder block or a cylinder head, and causing a pressure change in the cylinder to act on a pressure detection element via the hole, or a method for detecting the in-cylinder pressure by the pressure detection element attached to the tip of a direct injection injector.

For example, PTL 1 discloses a technique in which the control performance immediately after a transition to a specific operation state is improved in a case where the control of the air-fuel ratio according to statistics calculated from the detected in-cylinder pressure is performed in the specific operation state (steady operation state).

### CITATION LIST

### Patent Literature

PTL 1: JP 2000-170572 A

### SUMMARY OF INVENTION

### Technical Problem

By the way, an air-fuel ratio control apparatus for an internal combustion engine described in PTL 1 uses a standard deviation GIMEP of an indicated mean effective pressure IMEP (Indicated Mean Effective Pressure) as a parameter indicating the combustion state of an engine. PTL 1 describes that, when the combustion state deteriorates, a lean burn correction coefficient is corrected in a rich direction, and when the combustion state is very good, the lean burn correction coefficient is corrected in the lean direction, so that an appropriate air-fuel ratio can be made lean according to the actual combustion state to improve fuel efficiency while ensuring the operability of the engine. In the steady operation state, the combustion state can be detected with high accuracy by using the standard deviation σIMEP of the indicated mean effective pressure as a parameter. However, the calculation of the standard deviation σIMEP of the indicated mean effective pressure requires a relatively large number of pieces of combustion cycle data. Therefore, during a transient operation where the engine speed, accelerator opening, or load changes due to a driver operation or an EGR operation, it may be not reflected in the lean burn correction coefficient until the predetermined number of combustion cycles elapses. Therefore, it becomes difficult to cope with misfire due to sudden combustion deterioration and generation of vibration due to torque fluctuation, and there is a concern about drivability deterioration.

The present invention has been made in view of the above problem, and an object thereof is to provide a technique which can reduce a rapid combustion deterioration in an internal combustion engine.

### Solution to Problem

According to an aspect in order to achieve the above object, there is provided a control device for an internal combustion engine which burns fuel in a cylinder. The control device includes a determination unit which determines a target air-fuel ratio of the internal combustion engine based on a variation in crank angle in a relatively small number of combustion cycles or a difference in indicated mean effective pressure from a previous combustion cycle and an air-fuel ratio control unit which controls an air-fuel ratio of the internal combustion engine to be the target air-fuel ratio determined by the determination unit.

### Advantageous Effects of Invention

According to the present invention, deterioration of combustion in an internal combustion engine can be reduced.

### BRIEF DESCRIPTION OF DRAWINGS

FIG. 1 is a configuration diagram of an engine and its surroundings according to a first embodiment.

FIG. 2 is an entire configuration diagram of an internal combustion engine system.

FIG. 3 is a block diagram illustrating a configuration of an ECU.

FIG. 4 is a P-θ diagram illustrating an example of a change in in-cylinder pressure in one combustion cycle.

FIG. 5 is a flowchart of a standard deviation calculation process for obtaining σθPmax.

FIG. 6 is a diagram for describing a method for obtaining IMEP from a P-θ diagram.

FIG. 7 is a flowchart of a fluctuation rate calculation process of an indicated mean effective pressure for obtaining ΔIMEP and CPi.

FIG. 8 is a diagram illustrating an example of an air-fuel ratio control based on CPi.

FIG. 9 is a flowchart illustrating an example of the air-fuel ratio control based on CPi.

FIG. 10 is a diagram illustrating a problem of the air-fuel ratio control based on CPi.

FIG. 11 is a diagram illustrating an example of the air-fuel ratio control according to the first embodiment.

FIG. 12 is a flowchart illustrating an example of the air-fuel ratio control according to the first embodiment.

FIG. 13 is a flowchart illustrating an example of another air-fuel ratio control according to the first embodiment.

FIG. 14 is a diagram for describing a method for determining an air-fuel ratio correction amount according to a second embodiment.

FIG. 15 is a diagram for describing a method for determining an air-fuel ratio correction amount according to a third embodiment.

FIG. 16 is a diagram for describing a method for determining the air-fuel ratio correction amount according to a fourth embodiment.

### DESCRIPTION OF EMBODIMENTS

Hereinafter, embodiments of the invention will be described in detail using the drawings. Further, the embodiments described below do not limit the scope of the invention. Not all the elements and combinations thereof described in the embodiments are essential to the solution of the invention.

### First Embodiment

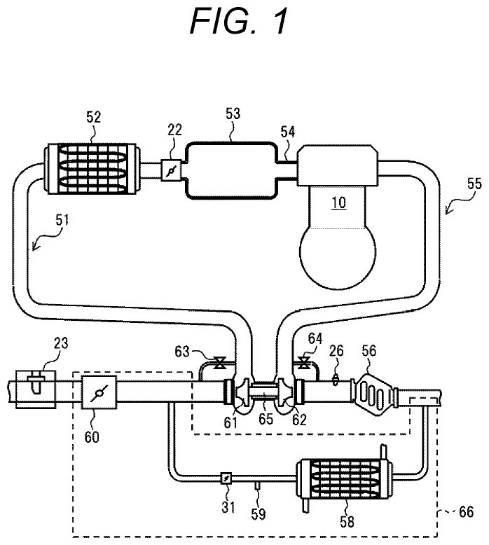

FIG. 1 is a configuration diagram of an engine and its surroundings according to a first embodiment.

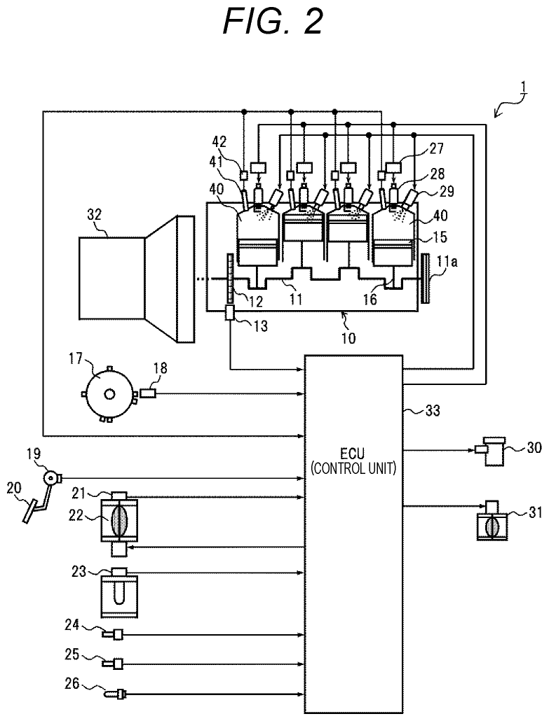

An engine 10 as an example of the “internal combustion engine” is, for example, a spark ignition type multi-cylinder engine equipped with four cylinders. A combustion chamber 40 (see FIG. 2) of each cylinder has an upstream communication with an intake system 51 and a downstream communication with an exhaust system 55. The intake system 51 includes an air flow sensor 23, a negative pressure generation valve 60, a compressor 61, an intercooler 52, an electronic control throttle valve 22, a collector 53, and an intake manifold 54 in order from the upstream.

The air flow sensor 23 detects the amount of intake air. The negative pressure generation valve 60 adjusts the flow rate of the intake air. The compressor 61 compresses the intake air. The pipes on the upstream and downstream sides of the compressor 61 are connected via a pipe provided with a recirculation valve 63 so that the intake air flows by bypassing the compressor 61. The recirculation valve 63 adjusts the amount of intake air that flows by bypassing the compressor 61.

The intercooler 52 cools the intake air. The electronic control throttle valve 22 adjusts the flow rate of the intake air into the combustion chamber 40. The collector 53 temporarily stores the intake air, thereby relaxing the flow rate of the intake air and leveling the increase/decrease. The intake manifold 54 distributes the intake air to the combustion chamber 40 of each cylinder.

The exhaust system 55 includes a turbine 62, an air-fuel ratio sensor 26, and a three-way catalyst 56 in an order from the upstream. The turbine 62 is connected to the compressor 61 disposed in the intake system 51 via a shaft 65. When the pressure of the exhaust gas discharged from the combustion chamber 40 of the engine 10 is equal to or more than a predetermined value, the turbine 62 rotates and the compressor 61 starts supercharging. The pipes on the upstream and downstream sides of the turbine 62 are connected via a pipe provided with a waste gate valve 64 so that the exhaust gas flows by bypassing the turbine 62. The waste gate valve 64 adjusts the exhaust gas flowing by bypassing the turbine 62.

The air-fuel ratio sensor 26 detects an air-fuel ratio (A/F: air/fuel) from the oxygen concentration in the exhaust gas. In the three-way catalyst 56, for example, platinum and palladium are coated on a carrier of alumina and ceria, and the exhaust gas is purified.

Further, the downstream side of the three-way catalyst 56 in the exhaust system 55 and the upstream side of the compressor 61 in the intake system 51 are connected through an EGR (Exhaust Gas Recirculation) system 66 through which the exhaust gas generated in the combustion chamber 40 recirculates from the exhaust system 55 to the intake system 51. The EGR system 66 includes an EGR cooler 58, an EGR temperature sensor 59, and an EGR valve 31 in an order from the upstream. The EGR cooler 58 cools EGR gas (exhaust gas). The EGR temperature sensor 59 measures the temperature of the EGR gas. The EGR valve 31 adjusts the recirculation amount of the EGR gas.

The exhaust gas of the exhaust system 55 flows from the exhaust system 55 to the EGR system 66 on the downstream side of the three-way catalyst 56, and the hot EGR gas that has flowed to the EGR system 66 is cooled via the EGR cooler 58. The cooled EGR gas is adjusted to a predetermined flow rate via the EGR valve 31, and then mixed with the intake air on the upstream side of the compressor 61 in the intake system 51.

FIG. 2 is an entire configuration diagram of an internal combustion engine system.

An internal combustion engine system 1 includes the engine 10 and an ECU (engine control unit) 33 as an example of a “determination unit” and an “air-fuel ratio control unit”.

The engine 10 has a crankshaft 11 and transmits the combustion and explosion energy of the combustible air-fuel mixture from a piston 15 to the crankshaft 11 via a connecting rod 16 to generate a rotational driving force. At one end of the crankshaft 11, a ring gear integrated with a drive plate for transmitting a driving force to a transmission 32, and a torque converter (both not illustrated) are attached. The output of the torque converter is input to the transmission 32. The driving force of the engine 10 is transmitted from the drive shaft (not illustrated) to the tire via the transmission 32 and then to a road surface. Here, the engine 10 may be any driving force source for running the vehicle, and examples thereof include a port injection type, an in-cylinder injection type gasoline engine, or a diesel engine.

The other end of the crankshaft 11 is attached with a crankshaft pulley 11a for belt-driving accessories. In addition, a crank angle signal plate 12 for detecting the angle (crank angle) of the crankshaft 11 is attached to the crankshaft 11. A predetermined uneven pattern for detecting a crank angle signal is engraved on the circumference of the crank angle signal plate 12.

A crank angle sensor 13 is attached in the vicinity of the outer peripheral side of the crank angle signal plate 12. When the crankshaft 11 rotates, the crank angle sensor 13 detects the uneven pattern engraved on the circumference of the crank angle signal plate 12, and outputs a pulse signal to the ECU 33. The ECU 33 calculates a crank angle and a rotation speed (rotation frequency) of the engine 10 on the basis of the pulse signal input from the crank angle sensor 13.

A through hole passing up to the combustion chamber 40 is provided in the upper portion of the engine 10, and an in-cylinder pressure sensor 41 for detecting the pressure in the combustion chamber 40 is inserted through the through hole. The output of the in-cylinder pressure sensor 41 is amplified by the charge amplifier 42 and input to the ECU 33. Further, a spark plug 28 and an injector 29 are arranged in the upper portion of the engine 10. When a high voltage is supplied from a spark coil 27, the spark plug 28 ignites the air-fuel mixture in the combustion chamber 40. The injector 29 injects fuel into the combustion chamber 40.

In addition to the sensors described above, the ECU 33 receives signals from a cam angle sensor 18, an accelerator opening sensor 19, a throttle opening sensor 21, a cooling water temperature sensor 24, and an intake air temperature sensor 25. The cam angle sensor 18 detects the uneven pattern of a cam angle signal plate 17 attached to the tip of a cam shaft that drives the intake valve and the exhaust valve of the combustion chamber 40, and performs cylinder discrimination. The accelerator opening sensor 19 detects the depression amount of an accelerator pedal 20 in a cab. The throttle opening sensor 21 detects the opening of the electronic control throttle valve 22. The cooling water temperature sensor 24 detects the temperature of the cooling water of the engine 10. The intake air temperature sensor 25 detects the temperature of the intake air. The ECU 33 controls the electronic control throttle valve 22, the spark coil 27, the injector 29, a high-pressure fuel pump 30, and the EGR valve 31. The high-pressure fuel pump 30 supplies fuel.

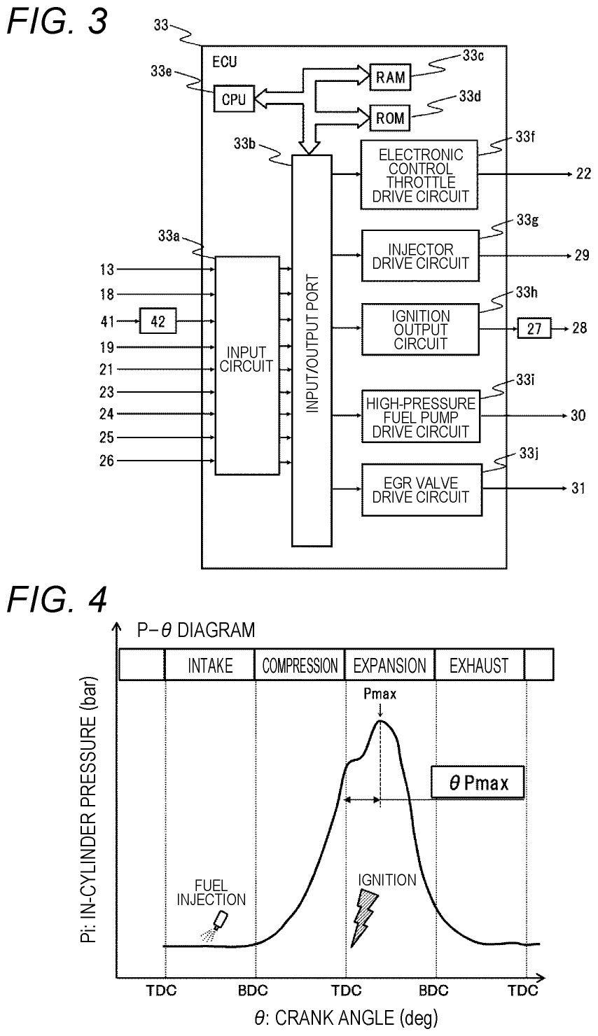

FIG. 3 is a block diagram illustrating a configuration of the ECU.

The ECU 33 includes an input circuit 33a, an input/output port 33b, a RAM 33c, a ROM 33d, and a CPU 33e.

The input circuit 33a receives signals from the crank angle sensor 13, the cam angle sensor 18, the in-cylinder pressure sensor 41, the accelerator opening sensor 19, the throttle opening sensor 21, the air flow sensor 23, the cooling water temperature sensor 24, the intake air temperature sensor 25, and the air-fuel ratio sensor 26.

However, the signals input from the sensors are not limited to above signals. The signal input from each sensor is sent to the input port in the input/output port 33b. The value sent to the input port of the input/output port 33b is stored in the RAM 33c, and is processed by the CPU 33e. A control program describing the contents of the arithmetic processing is written in advance in the ROM 33d.

The value calculated according to the control program is stored in the RAM 33c, then sent to the output port in the input/output port 33b, and sent to each actuator through each drive circuit. The ECU 33 of this embodiment includes an electronic control throttle drive circuit 33f, an injector drive circuit 33g, an ignition output (drive) circuit 33h, a high-pressure fuel pump drive circuit 33i, and an EGR valve drive circuit 33j as drive circuits. The electronic control throttle drive circuit 33f drives the electronic control throttle valve 22. The injector drive circuit 33g drives the injector 29. The ignition output circuit 33h drives the spark coil 27 The high-pressure fuel pump drive circuit 33i drives the high-pressure fuel pump 30. The EGR valve drive circuit 33j drives the EGR valve 31. The ECU 33 of this embodiment includes the drive circuits 33f to 33j, but is not limited thereto, and may include only one of the drive circuits 33f to 33j.

In order to handle the in-cylinder pressure signal by the ECU 33, the crank angle detected by the crank angle sensor 13 and the in-cylinder pressure detected by the in-cylinder pressure sensor 41 corresponding to the crank angle are measured. The measured data are processed by the CPU 33e, and are once stored in the RAM 33c as in-cylinder pressure data together with the crank angle for each combustion cycle.

The ECU 33 has a function of comparing a parameter indicating a combustion stability calculated based on the in-cylinder pressure signal with a determination threshold. In a case where the combustion stability is secured, the ECU 33 shifts the current target air-fuel ratio (target air-fuel ratio) toward a lean side (the fuel injection amount is reduced). On the other hand, the ECU 33 has a function of comparing the parameter indicating the combustion stability with the determination threshold to determine a target air-fuel ratio. In a case where it is determined that the target air-fuel ratio is lowered, the ECU 33 shifts the target air-fuel ratio toward a rich side (the fuel injection amount is increased).

The ECU 33 calculates a fuel amount corresponding to the amount of intake air measured by the air flow sensor 23, and controls the injector 29 so that the calculated fuel amount is obtained. The ECU 33 starts fuel injection by the injector 29 at a timing when the crank angle indicated by the signal of the crank angle sensor 13 becomes a predetermined crank angle.

When the fuel is injected by the injector 29, the sucked air and the fuel injected from the injector 29 are mixed in the combustion chamber 40 of the engine 10 to form a combustible air-fuel mixture. A high voltage boosted by the spark coil 27 is applied to the spark plug 28 at a timing when the crank angle detected by the crank angle sensor 13 becomes a crank angle preset by the ECU 33. Thereby, the combustible air-fuel mixture in the cylinder is ignited, burns, and explodes.

Conventionally, lean burn combustion is one of the fuel consumption reduction techniques. The lean burn combustion is a technique to reduce fuel combustion by operating in a lean burn state such as “20” or higher of the air-fuel ratio after taking measures such as reducing NOx such as catalyst, optimizing the combustion chamber shape and injector spray. However, there is a limit to the air-fuel ratio that can be operated as a lean burn depending on engine performance, fuel properties, variations among cylinders, and operating conditions. For this reason, in the vicinity of the lean limit, fluctuation occurs in the combustion generation torque to cause unstable, which is transmitted as unpleasant vibration to the driver and passengers via the drive system.

In order to operate the engine 10 in a stable lean burn combustion state, it is necessary to control an ignition timing, a fuel injection amount, and an injection timing before the lean limit. Therefore, it is necessary to accurately detect the combustion stability for each combustion cycle by detecting the torque generated during combustion or the in-cylinder pressure.

As a detection method of an indirect combustion stability, there are a method for measuring the distortion and vibration of a cylinder outer wall and converting the measured value into a torque through a filter, and a method for filtering and converting rotation fluctuation of the crankshaft 11 to a torque and taking statistics. In addition, as a direct detection method of combustion stability, a pressure sensor is attached to the spark plug 28 or the cylinder head of the engine 10, and the in-cylinder pressure is directly measured, and the measured value is converted into an indicated mean effective pressure (IMEP: indicated mean effective pressure). In this embodiment, the in-cylinder pressure is directly measured, and the indicated average effective pressure IMEP and the crank angle value θPmax indicating a maximum pressure value of the indicated average effective pressure IMEP are extracted to detect combustion stability.

Next, a method for detecting an in-cylinder pressure Pi and θPmax of the engine 10 will be described.

A sensor element for detecting distortion is attached to the tip of the in-cylinder pressure sensor 41 of each cylinder on the combustion chamber 40 side. When the pressure in the combustion chamber 40 changes, the sensor element outputs a charge signal corresponding to the pressure change. Since the charge signal output from the sensor element is minute, the charge signal is amplified by the charge amplifier 42, converted into a voltage signal (for example, 0 to 5 V), and output to the ECU 33. The ECU 33 calculates the in-cylinder pressure by multiplying the voltage input from the charge amplifier 42 by a conversion coefficient corresponding to the sensor characteristic. The timing for calculating the in-cylinder pressure is set for each crank angle detected by the crank angle sensor 13 (for example, every 100). The calculation result of the in-cylinder pressure corresponding to each crank angle is stored in the RAM 33c.

FIG. 4 is a P-θ diagram illustrating an example of a change in in-cylinder pressure in one combustion cycle.

The vertical axis represents the in-cylinder pressure Pi, the horizontal axis represents the crank angle θ, and the center TDC is a P-θ diagram illustrating the compression top dead center. In the intake stroke, the pressure changes near atmospheric pressure, and fuel is injected. In the compression stroke, since the piston 15 rises to TDC, the air-fuel mixture is compressed and the in-cylinder pressure Pi continues to increase. When the crank angle θ is ignited by the spark plug 28 before the TDC (for example, 30 degrees before), the air-fuel mixture compressed is combusted explosively in the vicinity of exceeding the TDC after starting combustion, and the in-cylinder pressure Pi increases further to push down the piston 15 vigorously. When the piston 15 descends, the volume in the cylinder increases, and the in-cylinder pressure Pi decreases. When the process proceeds to the exhaust stroke, the exhaust valve opens, the piston 15 turns to rise, and the exhaust gas is discharged, so that the in-cylinder pressure Pi becomes a pressure near atmospheric pressure. As described above, the in-cylinder pressure Pi becomes the maximum pressure Pmax at the time of combustion explosion. In this embodiment, the crank angle θ when the maximum pressure Pmax is generated is θPmax, and the standard deviation σθPmax for a plurality of relatively small number of combustion cycles (for example, the immediately preceding five cycles) is obtained and used as a parameter to determine the combustion stability. Further, the relatively small number of combustion cycles are preferably two or more cycles and less than 100 combustion cycles.

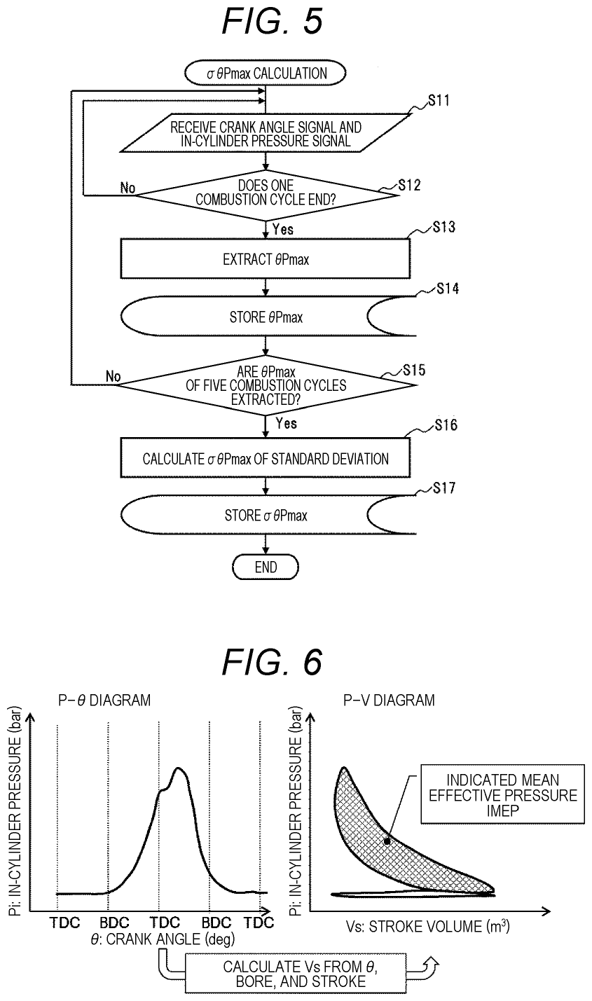

FIG. 5 is a flowchart of standard deviation calculation process for obtaining σθPmax.

The ECU 33 takes in the crank angle and in-cylinder pressure data corresponding to the crank angle (Step S11). The ECU 33 determines whether one combustion cycle is completed (Step S12). In a case where the determination result of Step S12 is false (S12: NO), the process returns to Step S11. In a case where the determination result of Step S12 is true (S12: YES), the process proceeds to Step S13. The ECU 33 extracts the crank angle θPmax that maximizes the in-cylinder pressure data from the obtained crank angle and in-cylinder pressure data (Step S13). The ECU 33 stores θPmax extracted in Step S13 in the RAM 33c (Step S14). The ECU 33 determines whether θPmax for a plurality of combustion cycles (5 cycles in the example of FIG. 5) is extracted (Step S15). In a case where the determination result of Step S15 is false (S15: NO), the process returns to Step S11. In a case where the determination result in Step S15 is true (S15: YES), the ECU 33 calculates a standard deviation σθPmax of θPmax (Step S16). The ECU 33 stores GθPmax calculated in Step S16 in the RAM 33c (Step S17).

FIG. 6 is a diagram for describing a method for obtaining IMEP from the P-θ diagram.

A stroke volume Vs is calculated on the basis of the crank angle θ on the horizontal axis of the P-θ diagram illustrated on the left side of FIG. 6, a bore, and the stroke, and the P-V diagram is obtained. The area indicated by the shaded portion of the P-V diagram on the right side of FIG. 6 is the indicated mean effective pressure IMEP. The indicated mean effective pressure IMEP is expressed by the following Equation (1), where the stroke volume is Vs, the in-cylinder pressure is Pi, and the change in combustion chamber volume is dV.

$$[ Math . 1 ]$$

$$IMEP = \frac{1}{Vs} ∮ PidV [ bar ] \qquad ( 1 )$$

Next, a method for obtaining a fluctuation rate CPi from the indicated mean effective pressure IMEP calculated by the equation (1) will be described. The fluctuation rate CPi of the indicated mean effective pressure IMEP is expressed by the following Equation (2). The standard deviation of values obtained by sampling the indicated mean effective pressure IMEP over a plurality of combustion cycles (for example, 400 cycles) is σIMEP, and the average value is AveIMEP.

$$[ Math . 2 ]$$

$$CPi = \frac{σ IMEP}{AveIMEP} \times 100 [ \% ] \qquad ( 2 )$$

The fluctuation rate CPi of the indicated mean effective pressure IMEP is used as a parameter for determining combustion stability over a long period (span) in a relatively large number of combustion cycles of 100 cycles or more. Further, a relatively large number of combustion cycles is preferably larger than a plurality of relatively small numb of combustion cycles, and is preferably 100 cycles or more and less than 700 cycles.

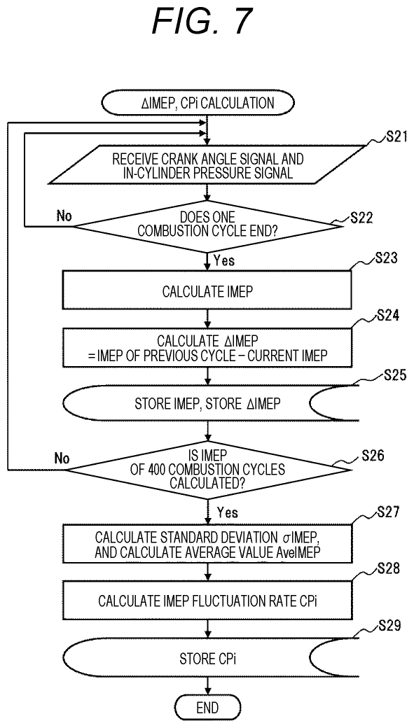

FIG. 7 is a flowchart of a fluctuation rate calculation process of the indicated mean effective pressure for obtaining ΔIMEP and CPi.

The ECU 33 takes in the crank angle and in-cylinder pressure data corresponding to the crank angle (Step S21). The ECU 33 determines whether one combustion cycle is completed (Step S22). In a case where the determination result of Step S22 is false (S22: NO), the process returns to S21. In a case where the determination result in S22 is true (S22: YES), the process proceeds to Step S23. The ECU 33 calculates the indicated mean effective pressure IMEP from the above-described Expression 1 (Step S23). The ECU 33 calculates a difference ΔIMEP from the immediately preceding combustion cycle (Step S24). The ECU 33 stores the indicated mean effective pressure IMEP calculated in Step S23 and ΔIMEP calculated in Step S24 in the RAM 33c (Step S25).

The ECU 33 determines whether the indicated mean effective pressure IMEP for a plurality of combustion cycles (400 cycles in the example of FIG. 7) is calculated (Step S26) In a case where the determination result of Step S26 is false (S26: NO), the process returns to Step S21. In a case where the determination result in Step S26 is true (S26: YES), the ECU 33 calculates the standard deviation σIMEP of the indicated mean effective pressure IMEP and the average value AveIMEP of the indicated mean effective pressure IMEP for 400 cycles (Step S27). The ECU 33 calculates the fluctuation rate CPi of the indicated mean effective pressure IMEP (Step S28). The ECU 33 stores the fluctuation rate CPi of the indicated mean effective pressure IMEP calculated in Step S28 in the RAM 33c (Step S29).

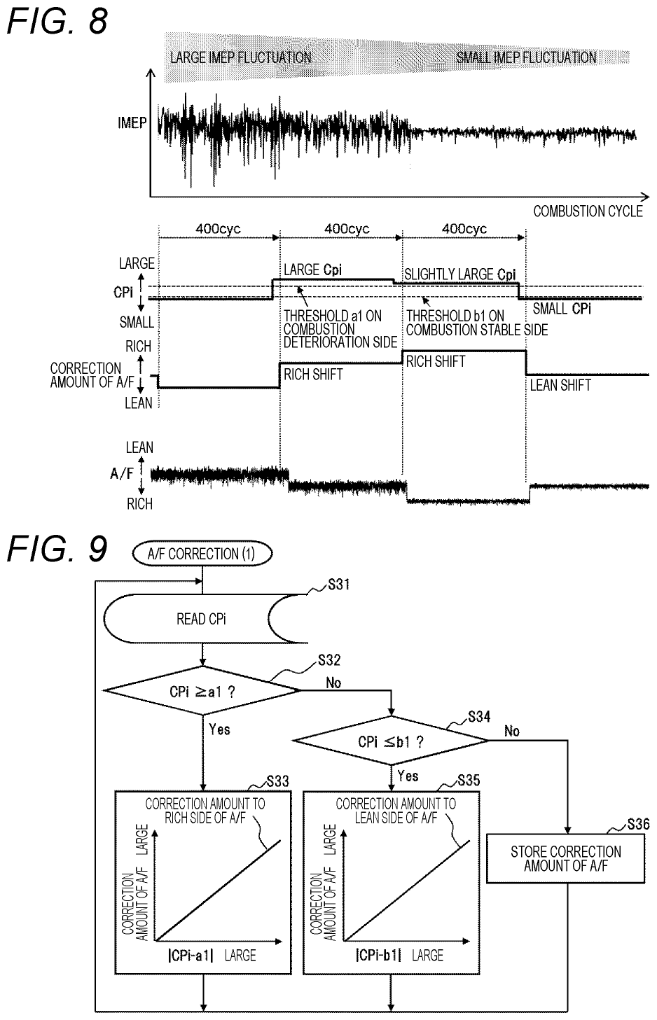

FIG. 8 is a diagram illustrating an example of the air-fuel ratio control based on CPi.

FIG. 8 illustrates a situation in which the cooling water temperature, the intake air temperature, the fuel temperature, and the like change during operation in a steady state, and the combustion state changes in a relatively long span. The ECU 33 calculates the fluctuation rate CPi of the indicated mean effective pressure IMEP, assuming that the number of combustion cycles necessary to calculate the parameter indicating combustion stability (hereinafter referred to as set cycle) is 400, determines that the combustion stability is decreased when the result exceeds the threshold a1 on the lean side, and corrects the air-fuel ratio to the rich side. Thereby, combustion stability improves and the fluctuation rate of the indicated mean effective pressure IMEP decreases. In addition, after the air-fuel ratio is corrected to the rich side, the air-fuel ratio becomes equal to or less than the determination threshold b1 on the combustion stable side. In a case where the combustion state is stabilized, the air-fuel ratio is corrected to the lean side. The correction amount of the air-fuel ratio differs depending on an absolute value of a deviation amount CPi-a1 from a determination threshold a1 or the deviation amount CPi-b1 from the determination threshold b1, and is large when the deviation amount is large and small when the deviation amount is small.

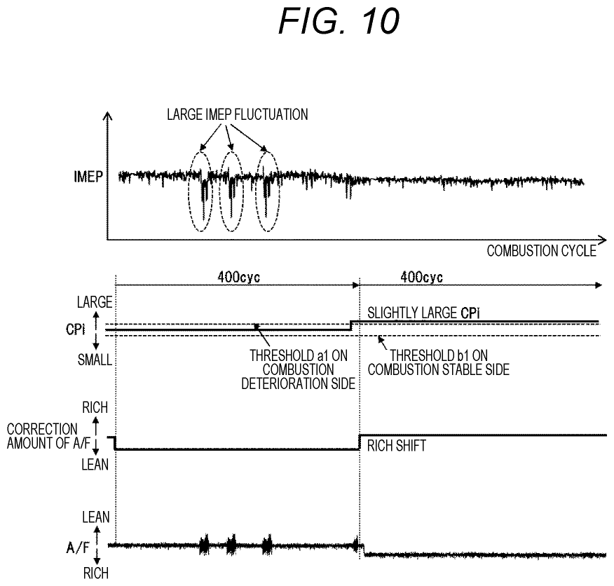

FIG. 9 is a flowchart illustrating an example of the air-fuel ratio control based on CPi.

The ECU 33 reads the fluctuation rate CPi of the indicated mean effective pressure IMEP calculated in the change rate calculation process of the indicated mean effective pressure of FIG. 7 (Step S31). The ECU 33 compares the fluctuation rate CPi of the indicated mean effective pressure IMEP read in Step S31 with the determination threshold a1 on the combustion deterioration side, and determines whether the fluctuation rate CPi of the indicated mean effective pressure IMEP is greater than or equal to a1. (Step S32). In a case where the determination result of Step S32 is true (S32: YES), the process proceeds to Step S33. The ECU 33 increases the correction amount to the rich side of the air-fuel ratio as the absolute value of CPi-a1 increases (Step S33). In a case where the determination result of Step S32 is false (S32: NO), the process proceeds to Step S34. The ECU 33 compares the fluctuation rate CPi of the indicated mean effective pressure IMEP read in Step S31 with the determination threshold b1 on the combustion stable side, and determines whether the fluctuation rate CPi of the indicated mean effective pressure IMEP is equal to or less than b1 (Step S34). In a case where the determination result of Step S34 is true (S34: YES), the process proceeds to Step S35. The ECU 33 increases the correction amount of the air-fuel ratio to the lean side as the absolute value of CPi-b1 increases (Step S35) In a case where the determination result of Step S34 is false (S34: NO), the process proceeds to Step S36. The ECU 33 keeps an air-fuel ratio correction amount at the previous correction amount (Step S36). The ECU 33 controls the air-fuel ratio of the engine 10 so that the determined correction amount is obtained.

As described above, in a steady operation state, under a situation where combustion deteriorates over a relatively long span, the fluctuation rate CPi of the indicated mean effective pressure IMEP with high accuracy is calculated with a relatively large number of combustion cycles such as 400 cycles. In a case where the fluctuation rate is reflected in the air-fuel ratio, it is possible to ensure combustion stability and suppress fuel consumption even near a combustion limit.

FIG. 10 is a diagram illustrating a problem of the air-fuel ratio control based on CPi.

If the driver operates the accelerator or the opening of the EGR valve 31 changes during the set cycle (400 cycles in the drawing) required to calculate the fluctuation rate CPi of the indicated mean effective pressure IMEP, a transient change in the load on the engine 10 may occur, and the fluctuation in the indicated mean effective pressure IMEP will increase and combustion stability may be reduced. In this case, the ECU 33 is not possible to correct the air-fuel ratio until the set cycle necessary for calculating the fluctuation rate CPi of the indicated mean effective pressure IMEP elapses. Therefore, the drivability is deteriorated without suppressing the vibration of the vehicle body due to the deterioration of combustion and the misfire in the combustion cycle.

Thus, the ECU 33 of this embodiment includes the fluctuation rate CPi of the indicated mean effective pressure IMEP and a parameter indicating combustion stability in a relatively small number of combustion cycles as parameters indicating combustion stability in order to cope with a transient change in the load on the engine 10. In this embodiment, as a parameter indicating the combustion stability in a relatively small number of combustion cycles, one of the standard deviation σθPmax of the crank angle θPmax that generates a maximum in-cylinder pressure Pmax, or a differences ΔIMEP from the indicated mean effective pressure IMEP of the immediately preceding combustion cycle is used.

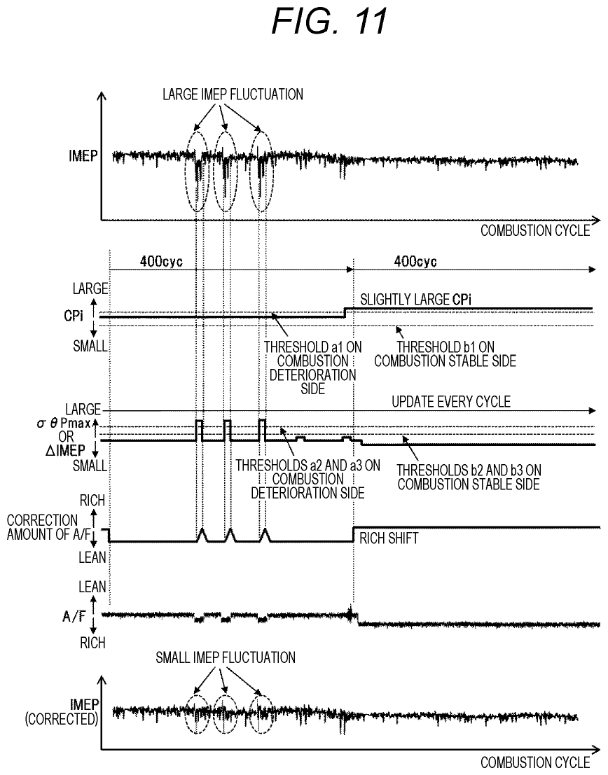

FIG. 11 is a diagram illustrating an example of the air-fuel ratio control according to the first embodiment.

If the combustion stability is determined using the fluctuation rate CPI of the indicated mean effective pressure IMEP as a parameter, the fluctuation rate CPi of the indicated mean effective pressure IMEP is calculated every 400 cycles. Therefore, even though combustion temporarily deteriorates during that cycle, the air-fuel ratio is not possible to be corrected immediately. On the other hand, if the combustion stability is determined using the standard deviation σθPmax of the crank angle θPmax that generates the maximum in-cylinder pressure Pmax or the difference ΔIMEP from the indicated mean effective pressure IMEP of the immediately preceding combustion cycle as a parameter, the combustion stability can be determined in a relatively small number of combustion cycles, and the air-fuel ratio can be corrected immediately. With this configuration, the fluctuation time of the indicated mean effective pressure IMEP can be suppressed short, and vibrations transmitted to the vehicle body and the occupant are reduced to improve drivability. Next, specific processing of the air-fuel ratio control will be described.

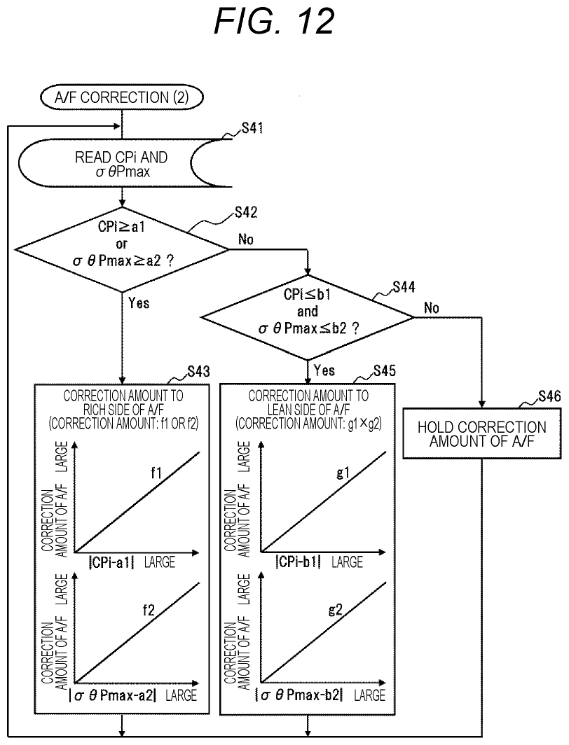

FIG. 12 is a flowchart illustrating an example of the air-fuel ratio control according to the first embodiment.

The ECU 33 reads the fluctuation rate CPi of the indicated mean effective pressure IMEP calculated in the change rate calculation process of the indicated mean effective pressure of FIG. 7, and the standard deviation σθPmax of the crank angle θPmax that generates the maximum in-cylinder pressure Pmax calculated by the standard deviation calculation process of FIG. 5 (Step S41). The ECU 33 determines whether the fluctuation rate CPi of the indicated mean effective pressure IMEP is equal to or more than the determination threshold a1 on the combustion deterioration side, or whether the standard deviation σθPmax of the crank angle θPmax that generates the maximum in-cylinder pressure Pmax is equal to or more than a determination threshold a2 (first setting value) is determined (Step S42). In a case where the determination result of Step S42 is true (S42: YES), the process proceeds to Step S43. In a case where the fluctuation rate CPi of the indicated mean effective pressure IMEP is equal to or more than the determination threshold a1 on the combustion deterioration side, the ECU 33 determines the correction amount (f1) to the rich side of the air-fuel ratio so as to increase as the absolute value of CPi−a1 increases. In a case where the standard deviation σθPmax of the crank angle θPmax that generates the maximum in-cylinder pressure Pmax is equal to or more than the determination threshold a2 (first setting value) on the combustion deterioration side, the ECU 33 determines the correction amount (f2) to the rich side of the air-fuel ratio so as to increase as the absolute value of σθPmax−a2 increase (Step S43). In a case where the determination result of Step S42 is false (S42: NO), the process proceeds to Step S44. The ECU 33 determines whether the fluctuation rate CPi of the indicated mean effective pressure IMEP is equal to or less than the determination threshold b1 on the combustion stable side, and whether the standard deviation σθPmax of the crank angle θPmax that generates the maximum in-cylinder pressure Pmax is equal to or less than the determination threshold b2 (third setting value) is determined (Step S44). In a case where the determination result of Step S44 is true (S44: YES), the process proceeds to Step S45. The ECU 33 obtains a correction reference amount (g1) determined so as to increase as the absolute value of CPi−b1 increases, obtains a correction reference amount (g2) determined so as to increase as the absolute value of σθPmax−b2 increases, and determines the correction amount to the lean side of the air-fuel ratio so as to increase as a product (g1×g2) of the correction reference amount (g1) and the correction reference amount (g2) increases (Step S45). In a case where the determination result of Step S44 is false (S44: NO), the process proceeds to Step S46. The ECU 33 keeps the correction amount of the air-fuel ratio at the previous correction amount (Step S46). The ECU 33 controls the air-fuel ratio of the engine 10 so that the determined correction amount is obtained.

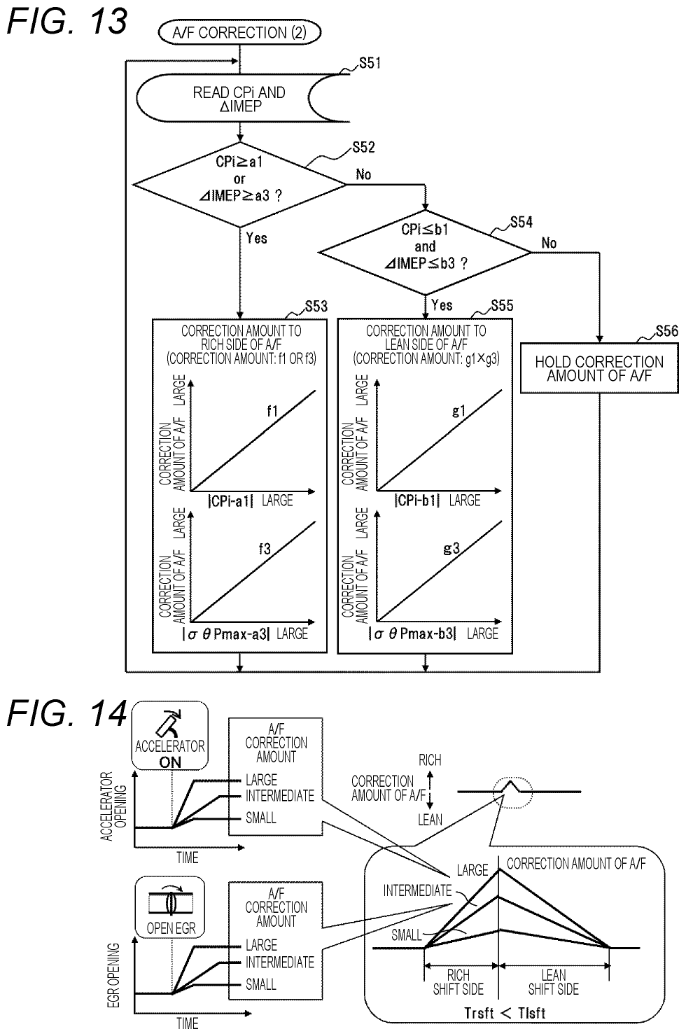

FIG. 13 is a flowchart illustrating an example of another air-fuel ratio control according to the first embodiment.

The ECU 33 reads the fluctuation rate CPi of the indicated mean effective pressure IMEP calculated in the process of FIG. 7 and the difference ΔIMEP from the indicated mean effective pressure IMEP of the immediately preceding combustion cycle (Step S51). The ECU 33 determines whether the fluctuation rate CPi of the indicated mean effective pressure IMEP is equal to or more than the determination threshold a1 on the combustion deterioration side, or whether the difference ΔIMEP from the indicated mean effective pressure IMEP of the immediately preceding combustion cycle is equal to or more than the determination threshold a3 (second setting value) on the combustion deterioration side (Step S52) In a case where the determination result of Step S52 is true (S52: YES), the process proceeds to Step S53.

In a case where the fluctuation rate CPi of the indicated mean effective pressure IMEP is equal to or more than the determination threshold a1 on the combustion deterioration side, the ECU 33 determines the correction amount (f1) to the rich side of the air-fuel ratio so as to increase as the absolute value of CPi−a1 increases. In a case where the difference ΔIMEP from the indicated mean effective pressure IMEP of the immediately preceding combustion cycle is equal to or more than the determination threshold a3 on the combustion deterioration side, the ECU 33 determines the correction amount (f3) to the rich side of the air-fuel ratio so as to increase as the absolute value of σθPmax−b2 increases (Step S53). In a case where the determination result of Step S52 is false (S52: NO), the process proceeds to Step S54. The ECU 33 determines whether the fluctuation rate CPi of the indicated mean effective pressure IMEP is equal to or less than the determination threshold b1 on the combustion stable side, and whether the difference ΔIMEP from the indicated mean effective pressure IMEP of the immediately preceding combustion cycle is equal to or less than the determination threshold b3 (fourth setting value) on the combustion stable side (Step S54). In a case where the determination result of Step S54 is true (S54: YES), the process proceeds to Step S55. The ECU 33 obtains the correction reference amount (g1) determined so as to increase as the absolute value of CPi−b1 increases, obtains the correction reference amount (g3) determined so as to increase as the absolute value of σθPmax−b3 increases, and determines the correction amount (g1×g2) to the lean side of the air-fuel ratio so as to increase as the product of the correction reference amount (g1) and the correction reference amount (g3) increases (Step S55). In a case where the determination result of Step S54 is false (S44: NO), the process proceeds to Step S56. The ECU 33 keeps the correction amount of the air-fuel ratio at the previous correction amount (Step S56). The ECU 33 controls the air-fuel ratio of the engine 10 so that the determined correction amount is obtained.

The correction amount to the rich side of the air-fuel ratio in these Steps S43 and S53 and the correction amount to the lean side of the air-fuel ratio in Steps S45 and S55 increase as the absolute values of the differences between the parameters indicating the combustion stability and the determination threshold. In other words, when the deviation from each threshold is large, each correction amount increases to improve the responsiveness, and the air-fuel ratio is quickly shifted to the rich side or the lean side to ensure combustion stability. Further, in a case where the air-fuel ratio is shifted to the lean side, the fuel consumption can be reduced.

As described above, in this embodiment, parameters indicating combustion stability having different characteristics are calculated on the basis of the crank angle or in-cylinder pressure data corresponding to the crank angle. With this configuration, the deterioration of the combustion state due to the transient change of the operating condition can be detected quickly, and the air-fuel ratio control can be performed at that stage. The deterioration of the drivability can be suppressed even in the lean limit region due to lean burn. Further, in a case where the combustion state is stabilized after the air-fuel ratio is corrected to the rich side, an increase in combustion consumption can be suppressed by shifting the air-fuel ratio to the lean side.

### Second Embodiment

Next, the ECU 33 according to a second embodiment will be described. Further, the ECU 33 according to the second embodiment differs from the ECU 33 according to the first embodiment only in the method for determining the correction amount of the air-fuel ratio, and the hardware configuration is the same as the ECU 33 according to the first embodiment.

FIG. 14 is a diagram for describing a method for determining an air-fuel ratio correction amount according to the second embodiment.

When the air-fuel ratio is corrected to the rich side, the load on the engine 10 may change depending on the change in the throttle opening or the change in the EGR amount due to the driver's accelerator operation. In this case, the ECU 33 refers to the amount of change in either the change amount of the throttle opening or the amount of change in the EGR opening, and changes the correction amount of the air-fuel ratio according to the referred amount of change. Each amount of change is divided by the opening degree and the change speed. In a case where the opening degree is large and the change speed is fast, a large correction amount is set. In a case where the opening degree is small and the change speed is slow, a small correction amount is set. In addition, the ECU 33 sets a transition time Trsft on a rich shift side shorter than a transition time Tlsft on a lean shift side in order to emphasize combustion stability when correcting the air-fuel ratio.

### Third Embodiment

Next, the ECU 33 according to a third embodiment will be described. The ECU 33 according to the third embodiment is an example in a case where the air-fuel ratio is shifted to the lean side, and the hardware configuration is the same as that of the ECU 33 according to the first embodiment.

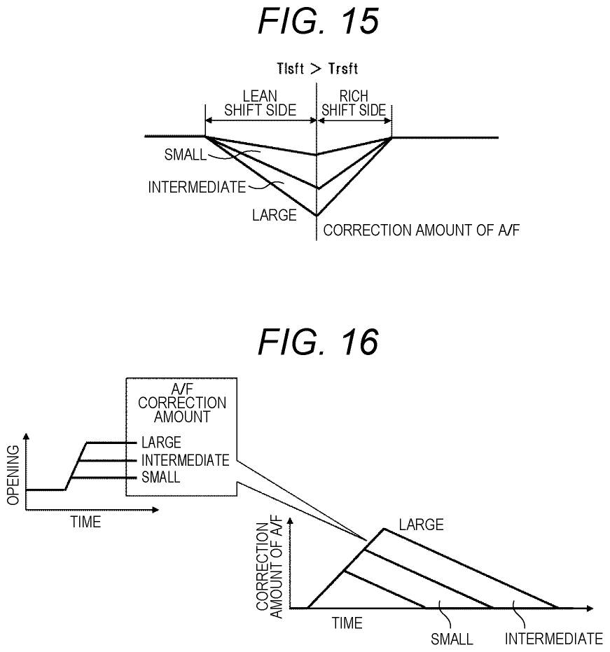

FIG. 15 is a diagram for describing a method for determining an air-fuel ratio correction amount according to the third embodiment.

When the IMEP fluctuates significantly on the increase side, either the amount of change in the throttle opening or the amount of change in the EGR opening is referred. The correction amount of the air-fuel ratio to the lean side increases as the referred amount of change increased. Similarly to in the second embodiment, when the air-fuel ratio is corrected, the shift time Trsft on the rich shift side is set shorter than the shift time Tlsft on the lean shift side in order to emphasize combustion stability.

### Fourth Embodiment

Next, the ECU 33 according to a fourth embodiment will be described. The ECU 33 according to the fourth embodiment differs from the ECU 33 according to the first embodiment only in the air-fuel ratio correction period, and the hardware configuration is the same as that of the ECU 33 according to the first embodiment.

FIG. 16 is a diagram for describing a method for determining the air-fuel ratio correction amount according to the fourth embodiment.

The ECU 33 increases the correction amount of the air-fuel ratio as the opening degree of the throttle or the EGR increases in a case where the changing speeds of the throttle opening degrees or the EGR opening degrees are equal and the changing amounts are different.

Further, the present invention is not limited to the above embodiments, but various modifications may be contained. For example, the above-described embodiments of the present invention have been described in detail in a clearly understandable way, and are not necessarily limited to those having all the described configurations. In addition, some of the configurations of a certain embodiment may be replaced with the configurations of the other embodiments, and the configurations of the other embodiments may be added to the configurations of the subject embodiment. In addition, some of the configurations of each embodiment may be omitted, replaced with other configurations, and added to other configurations.

In the above embodiment, the ECU 33 uses the fluctuation rate CPi of the indicated mean effective pressure IMEP and the parameter indicating the combustion stability in a relatively small number of combustion cycles as the parameters indicating the combustion stability. However, the ECU 33 may use only the parameter indicating the combustion stability in a relatively small number of combustion cycles as a parameter indicating the combustion stability.

In the above embodiment, in Step S42, the ECU 33 determines whether the fluctuation rate CPi of the indicated mean effective pressure IMEP is equal to or more than the determination threshold a1 on the combustion deterioration side, or whether the standard deviation σθPmax of the crank angle θPmax that generates the maximum in-cylinder pressure Pmax is equal to or more than the determination threshold a2 on the combustion deterioration side. The ECU 33 may determine whether the fluctuation rate CPi of the indicated mean effective pressure IMEP is equal to or more than the determination threshold a1 on the combustion deterioration side of the CPi, and whether the standard deviation σθPmax of the crank angle θPmax that generates the maximum in-cylinder pressure Pmax is equal to or more than the determination threshold a2 on the combustion deterioration side.

In the above embodiment, in Step S52, the ECU 33 determines whether the fluctuation rate CPi of the indicated mean effective pressure IMEP is equal to or more than the determination threshold a1 on the combustion deterioration side, or whether the difference ΔIMEP from the indicated mean effective pressure IMEP of the immediately preceding combustion cycle is equal to or more than the determination threshold a3 on the combustion deterioration side. The ECU 33 may determine whether the fluctuation rate CPi of the indicated mean effective pressure IMEP is equal to or more than the determination threshold a1 on the combustion deterioration side, and whether the difference ΔIMEP from the indicated mean effective pressure IMEP of the immediately preceding combustion cycle is equal to or more than the determination threshold a3 on the combustion deterioration side.

In the above embodiment, the previous combustion cycle is the immediately previous combustion cycle. The previous combustion cycle may be a combustion cycle two or more combustion cycles before.

In the second to fourth embodiments, the ECU 33 refers to either the amount of change in the throttle opening or the amount of change in the EGR opening, and changes the correction amount of the air-fuel ratio according to the amount of change. The ECU 33 may refer to the amount of change in the throttle opening and the amount of change in the EGR opening, and change the correction amount of the air-fuel ratio according to the amount of change.

In the second to fourth embodiments, the ECU 33 sets the transition time Trsft on the rich shift side to be shorter than the transition time Tlsft on the lean shift side when the air-fuel ratio is corrected. The ECU 33 may make the transition time Tlsft on the lean shift side and the transition time Trsft on the rich shift side to be the same period when the air-fuel ratio is corrected.

### REFERENCE SIGNS LIST

10 engine
33 ECU

1. A control device for an internal combustion engine which injects fuel in a cylinder, comprising:
a determination unit which determines a target air-fuel ratio of the internal combustion engine based on a variation in crank angle in a relatively small number of combustion cycles or a difference in indicated mean effective pressure from a previous combustion cycle; and
an air-fuel ratio control unit which controls an air-fuel ratio of the internal combustion engine to be the target air-fuel ratio determined by the determination unit.

2. The control device for the internal combustion engine according to claim 1, wherein the determination unit shifts the target air-fuel ratio to a rich side when the variation exceeds a first setting value or when the difference exceeds a second setting value.

3. The control device for the internal combustion engine according to claim 1, wherein the determination unit shifts the target air-fuel ratio to a lean side when the variation is equal to or less than a third setting value, or when the difference is equal to or less than a fourth setting value.

4. The control device for the internal combustion engine according to claim 1, wherein the variation is a standard deviation of the crank angle when an in-cylinder pressure is maximum in the relatively small number of combustion cycles.

5. The control device for the internal combustion engine according to claim 2, wherein the difference is a difference in indicated mean effective pressure from an immediately preceding combustion cycle.

6. The control device for the internal combustion engine according to claim 2, wherein the determination unit determines the target air-fuel ratio based on the variation in the crank angle in the relatively small number of combustion cycles, the difference in the indicated mean effective pressure from the previous combustion cycle, or a fluctuation rate of the indicated mean effective pressure in a relatively large number of combustion cycles.

7. The control device for the internal combustion engine according to claim 2, wherein the determination unit shifts the target air-fuel ratio to the rich side when the variation exceeds a first setting value and the difference exceeds a second setting value.

8. The control device for the internal combustion engine according to claim 2, wherein the determination unit determines a correction amount of the target air-fuel ratio according to an accelerator opening of the internal combustion engine.

9. The control device for the internal combustion engine according to claim 2, wherein the determination unit determines a correction amount of the target air-fuel ratio according to an EGR opening degree of the internal combustion engine.

10. The control device for the internal combustion engine according to claim 8, wherein the determination unit sets a transition period of the rich side to be shorter than a transition period of the lean side.

11. A method for controlling an internal combustion engine which injects fuel in a cylinder, comprising:
determining a target air-fuel ratio of the internal combustion engine based on a variation in crank angle in a relatively small number of combustion cycles or a difference in indicated mean effective pressure from a previous combustion cycle; and
performing control such that an air-fuel ratio of the internal combustion engine becomes the target air-fuel ratio determined by the determination unit.
